(19) United States
(12) Patent Application Publication
(10) Pub. No.: US 2026/0348363 A1
(43) Pub. Date: Nov. 5, 2026

(54) WATER DROPLET COLLISION COEFFICIENT DETERMINATION METHOD, APPARATUS AND TERMINAL FOR ICING OF WIND TURBINE BLADES, AND MEDIUM

(71) Applicant: ELECTRIC POWER RESEARCH INSTITUTE, CHINA SOUTHERN POWER GRID, Guangzhou, Guangdong (CN)

(72) Inventors: Caijin FAN, Guangzhou, Guangdong (CN); Lei LIU, Guangzhou, Guangdong (CN); Min LI, Guangzhou, Guangdong (CN); Tianwei LI, Guangzhou, Guangdong (CN); Bin LI, Guangzhou, Guangdong (CN); Lei JIA, Guangzhou, Guangdong (CN); Ruijian PAN, Guangzhou, Guangdong (CN); Zheng ZHONG, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 19/486,921

(22) PCT Filed: Oct. 24, 2023
(86) PCT No.: PCT/CN2023/126102

§ 371 Date: Nov. 22, 2025

(30) Foreign Application Priority Data
Jul. 21, 2023 (CN) 202310906033.1

(51) Int. Cl. F03D 80/40; F03D 17/00

(52) U.S. Cl. CPC F03D 80/405; F03D 17/005; F03D 17/0285

(57) ABSTRACT

A water droplet collision coefficient determination method for icing of wind turbine blades. The method comprises: calculating influence coefficients and disturbance potential data of wind turbine blade boundaries on the basis of a coordinate set of the wind turbine blade boundaries in combination with a boundary element algorithm; calculating an airflow speed of a boundary outfield area point; on the basis of an initialized water droplet and the airflow speed and by means of a Lagrange algorithm, determining the stress state of the water droplet; tracking a motion trajectory of the water droplet, and when the water droplet collides with the surface of a wind turbine blade, determining the collision position and collision speed of the water droplet; and obtaining a local collision coefficient of the collision position of the water droplet on the basis of the collision speed, a normal vector of the collision position, and the airflow speed.

The present application claims priority to Chinese patent application No. 202310906033.1, titled “WATER DROPLET COLLISION COEFFICIENT DETERMINATION METHOD, APPARATUS AND TERMINAL FOR ICING OF WIND TURBINE BLADES, AND MEDIUM”, filed on Jul. 21, 2023 with the China National Intellectual Property Administration, which is incorporated herein by reference in its entirety.

### FIELD

The present disclosure relates to the technical field of wind power generation simulation, and in particular to a method, an apparatus, and a terminal for determining a water droplet collision coefficient for icing of a wind turbine blade, and a medium.

### BACKGROUND

Wind energy, as a clean and renewable energy source, is being increasingly accepted and widely applied by a large quantity of countries. With the growing maturity of wind power generation technology, many developed countries have intensified investments in wind energy infrastructure, and the wind power generation industry in China is also experiencing rapid growth.

In recent years, wind power generation industries in regions such as Sichuan Province, Chongqing Municipality, and Yunnan Province in China have been increasing annually. Located in southwest China, these regions feature humid climates, as well as prominent plateaus and mountainous terrains. Temperatures in winter hover around 0 °C, providing environmental conditions conducive to icing, and thus an issue of icing of wind turbine blades becomes increasingly prominent, resulting in annual power generation losses caused by icing of wind turbine blades reaching up to 30%. Then, the icing of wind turbine blades alters the structure of wind turbines, causing technical components of wind turbines to become brittle and shortening the lifespan of wind turbines. Furthermore, when temperatures rise, ice fragments detach from the wind turbine blades and are violently thrown out due to a centrifugal force, posing severe threats to personnel safety at wind farms.

Given unique operating conditions of wind turbines and inadequacy of monitoring and early warning mechanisms for icing of blades, there is a critical approach that analogue simulation is performed on growth patterns and rates of icing based on environmental conditions. Currently, in a widely applied method, simulation is performed on flow field analysis, water droplet collision and freezing processes involved in icing of wind turbine blades through computational fluid dynamics (CFD) simulation and calculation software. However, this method requires a complex computational process. Moreover, due to a large size of a wind turbine and a high number of meshes, the computational efficiency is low, and application of this method to icing prediction and early warning in wind turbine engineering is restricted to some extent.

### SUMMARY

In the present disclosure, a method, an apparatus, and a terminal for determining a water droplet collision coefficient for icing of a wind turbine blade, and a medium are provided, and are intended to address a technical issue of low computational efficiency in conventional analogue simulation technology for icing of the wind turbine blade.

To address the aforementioned technical issues, in a first aspect of the present disclosure, a method for determining a water droplet collision coefficient for icing of a wind turbine blade includes:
calculating an influence coefficient and disturbance potential data of a boundary of the wind turbine blade based on a coordinate set of the boundary of the wind turbine blade in combination with a boundary element algorithm;
calculating an airflow velocity at a point in a flow field region outside the boundary based on the influence coefficient and the disturbance potential data;
determining a force state of a water droplet through a Lagrangian algorithm based on initialization of the water droplet and the airflow velocity;
tracking a motion trajectory of the water droplet based on the force state of the water droplet, and determining a collision position and a collision velocity of the water droplet when the water droplet collides with a surface of the wind turbine blade; and obtaining a local collision coefficient at the collision position of the water droplet based on the collision velocity, a normal vector at the collision position, and the airflow velocity, in combination with a local collision coefficient calculation equation for the water droplet.

In an embodiment, the local collision coefficient calculation equation for the water droplet is expressed as:

$${β}_{1}^{P} = \frac{{V}_{x} {n}_{jx} + {V}_{y} {n}_{jy}}{U} ,$$

where β₁^{P} represents a local collision coefficient of a water droplet P, Vₓ represents an x-axis component of the collision velocity, V_{y} represents a y-axis component of the collision velocity, U represents the airflow velocity, nⱼₓ represents an x-axis component of the normal vector at the collision position when the water droplet collides with the surface of the blade, and n_{jy} represents a y-axis component of the normal vector at the collision position when the water droplet collides with the surface of the blade.

In an embodiment, the calculating an airflow velocity at a point in a flow field region outside the boundary based on the influence coefficient and the disturbance potential data further includes:
calculating flow field disturbance potential data of the flow field region outside the boundary based on the influence coefficient and the disturbance potential data, in combination with a parametric relationship between the influence coefficient and the disturbance potential data; and
calculating the airflow velocity at the point in the flow field region outside the boundary based on a parametric relationship between the flow field disturbance potential data and the airflow velocity.

In an embodiment, before calculating the influence coefficient and the disturbance potential data of the boundary of the wind turbine blade in combination with the boundary element algorithm, the method further includes:
performing linear interpolation on coordinate points of the boundary of the wind turbine blade through a linear interpolation method based on the coordinate set of the boundary of the wind turbine blade, to obtain the interpolated coordinate set of the boundary of the wind turbine blade.

In an embodiment, the tracking a motion trajectory of the water droplet based on the force state of the water droplet, and determining a collision position and a collision velocity of the water droplet when the water droplet collides with a surface of the wind turbine blade further includes:
calculating, based on an initial position, an initial velocity, and the force state of the water droplet, in combination with a preset time step, a real-time position of the water droplet after the preset time step;
determining a collision state between the water droplet and the surface of the wind turbine blade through a vector determination method based on a position of the water droplet;
determining, when the water droplet collides with the surface of the wind turbine blade, the collision position and the collision velocity of the water droplet; and
calculating, when no collision occurs, the real-time position of the water droplet after the preset time step based on a current position in combination with the preset time step.

In an embodiment, the process of tracking the motion trajectory of the water droplet further includes:
based on the motion trajectory of the water droplet, in combination with a preset motion trajectory smoothness value, when a smoothness of the motion trajectory is less than the preset motion trajectory smoothness value, reducing the preset time step until the smoothness of the motion trajectory is not less than the preset motion trajectory smoothness value.

In an embodiment, the process of tracking the motion trajectory of the water droplet further includes:
based on a distance between the current position of the water droplet and the surface of the wind turbine blade, when the distance is greater than a preset distance threshold and the smoothness of the motion trajectory is not less than the preset motion trajectory smoothness value, increasing the preset time step.

Moreover, in a second aspect of the present disclosure, an apparatus for determining a water droplet collision coefficient for icing of a wind turbine blade is provided, and the apparatus includes a boundary element data calculation unit, a flow field airflow velocity calculation unit, a water droplet force analysis unit, a motion trajectory tracking unit, and a local collision coefficient calculation unit.

The boundary element data calculation unit is configured to calculate an influence coefficient and disturbance potential data of a boundary of the wind turbine blade based on a coordinate set of the boundary of the wind turbine blade in combination with a boundary element algorithm.

The flow field airflow velocity calculation unit is configured to calculate an airflow velocity at a point in a flow field region outside the boundary based on the influence coefficient and the disturbance potential data.

The water droplet force analysis unit is configured to determine a force state of a water droplet through a Lagrangian algorithm based on initialization of the water droplet and the airflow velocity.

The motion trajectory tracking unit is configured to track a motion trajectory of the water droplet based on the force state of the water droplet, and determine a collision position and a collision velocity of the water droplet when the water droplet collides with a surface of the wind turbine blade.

The local collision coefficient calculation unit is configured to obtain a local collision coefficient at the collision position of the water droplet based on the collision velocity, a normal vector at the collision position, and the airflow velocity, in combination with a local collision coefficient calculation equation for the water droplet.

In a third aspect of the present disclosure, a terminal for determining a water droplet collision coefficient for icing of a wind turbine blade includes a memory and a processor.

The memory stores a computer program executable on the processor.

The processor, when executing the computer program, implements the method for determining the water droplet collision coefficient for icing of the wind turbine blade according to the first aspect of the present disclosure.

In a fourth aspect of the present disclosure, a computer-readable storage medium is provided. The computer-readable storage medium stores computer-executable instructions. The computer-executable instructions, when executed by a control processor, cause the control processor to implement the method for determining the water droplet collision coefficient for icing of the wind turbine blade according to the first aspect of the present disclosure.

It can be seen from the above technical solutions that the present disclosure has the following advantages.

In the solution of the present disclosure, an airflow velocity at a point in a flow field region outside a boundary is obtained through a boundary element algorithm. A force state of a water droplet is determined through a Lagrangian algorithm, and a motion trajectory of the water droplet is tracked. Then a collision state of the water droplet is determined, and when the water droplet collides with a surface of a wind turbine blade, coordinates of a collision point and a collision velocity of the water droplet are rapidly calculated based on the force state and the motion trajectory of the water droplet. Finally, based on the collision velocity, a normal vector at the collision position, and the airflow velocity, in combination with a local collision coefficient calculation equation for the water droplet, necessary data for analysis of icing of the wind turbine blade, a local collision coefficient, is obtained. Through the method, there is no requirement for constructing a complex flow field mesh model, the computational efficiency is high, and the technical issue of low computational efficiency in conventional analogue simulation technology for icing of the wind turbine blade is addressed.

### BRIEF DESCRIPTION OF THE DRAWINGS

For clearer illustration of the technical solutions according to embodiments of the present disclosure or conventional technology, drawings to be applied in embodiments of the present disclosure or conventional technology are briefly described hereinafter. Apparently, the drawings in the following descriptions are only some embodiments of the present disclosure, and other drawings may be obtained by those skilled in the art based on the provided drawings without any creative effort.

FIG. 1 is a flowchart of a method for determining a water droplet collision coefficient for icing of a wind turbine blade according to an embodiment of the present disclosure;

FIG. 2 is a flowchart of a method for determining a water droplet collision coefficient for icing of a wind turbine blade according to another embodiment of the present disclosure;

FIG. 3 is a schematic diagram of trajectory tracking and calculation for a water droplet outside a wind turbine blade in the method for determining the water droplet collision coefficient for icing of the wind turbine blade according to the present disclosure;

FIG. 4 is a schematic diagram of a water droplet collision vector on a surface of a wind turbine blade in the method for determining the water droplet collision coefficient for icing of the wind turbine blade according to the present disclosure;

FIG. 5 is a comparison diagram between a local collision coefficient for a water droplet on a surface of a wind turbine blade obtained by the method for determining the water droplet collision coefficient for icing of the wind turbine blade according to the present disclosure and a local collision coefficient for a water droplet on a surface of a wind turbine blade obtained by a conventional computational fluid dynamics (CFD) method;

FIG. 6 is a schematic diagram of water droplet trajectories outside a wind turbine blade at different time steps in the method for determining the water droplet collision coefficient for icing of the wind turbine blade according to the present disclosure;

FIG. 7 is a schematic structural diagram of an apparatus for determining a water droplet collision coefficient for icing of a wind turbine blade according to an embodiment of the present disclosure; and

FIG. 8 is a schematic structural diagram of a terminal for determining a water droplet collision coefficient for icing of a wind turbine blade according to an embodiment of the present disclosure.

### DETAILED DESCRIPTION OF THE EMBODIMENTS

In an embodiment of the present disclosure, a method, an apparatus, and a terminal for determining a water droplet collision coefficient for icing of a wind turbine blade, and a medium are provided, and are intended to address a technical issue of low computational efficiency in conventional analogue simulation technology for icing of the wind turbine blade.

In order to make the objectives, features, and advantages of the present disclosure clearer and more comprehensible, the technical solutions in the embodiments of the present disclosure are described below with reference to the drawings in the embodiments of the present disclosure. Apparently, the embodiments described below are merely a part rather than all of the embodiments of the present disclosure. Any other embodiments obtained by those of ordinary skills in the art based on the embodiments in the present disclosure without any creative effort shall fall within the protection scope of the present disclosure.

First, a detailed description of a basic embodiment of the method for determining the water droplet collision coefficient for icing of the wind turbine blade according to the present disclosure is given as follows.

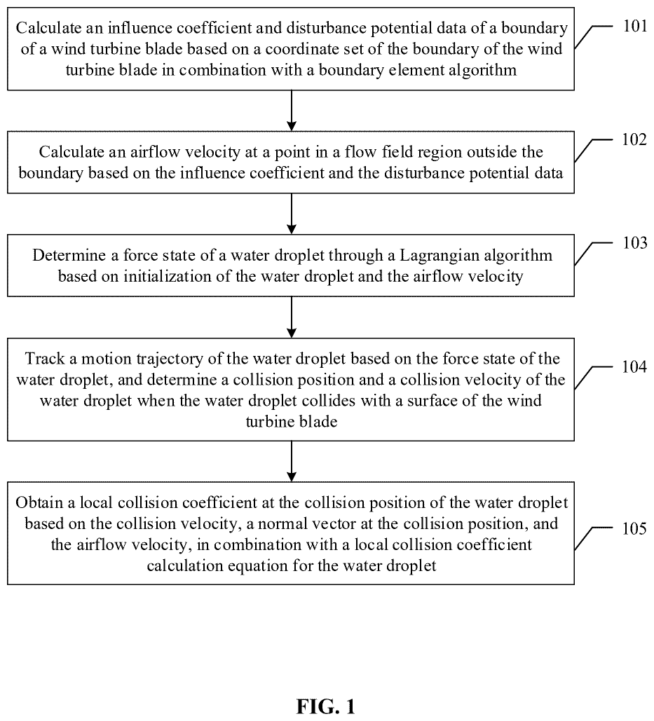

Referring to FIG. 1, a method for determining a water droplet collision coefficient for icing of a wind turbine blade according to a first embodiment of the present disclosure includes step 101 to step 105.

In step 101, an influence coefficient and disturbance potential data of a boundary of the wind turbine blade are calculated based on a coordinate set of the boundary of the wind turbine blade in combination with a boundary element algorithm.

In step 102, an airflow velocity at a point in a flow field region outside the boundary is calculated based on the influence coefficient and the disturbance potential data.

In step 103, a force state of a water droplet is determined through a Lagrangian algorithm based on initialization of the water droplet and the airflow velocity.

In step 104, a motion trajectory of the water droplet is tracked based on the force state of the water droplet, and a collision position and a collision velocity of the water droplet are determined when the water droplet collides with a surface of the wind turbine blade.

In step 105, a local collision coefficient at the collision position of the water droplet is obtained based on the collision velocity, a normal vector at the collision position, and the airflow velocity, in combination with a local collision coefficient calculation equation for the water droplet.

It should be noted that, first, a two-dimensional point coordinate set A of a boundary Γ of the wind turbine blade is obtained based on the structure of the wind turbine blade to be simulated. Then, based on the two-dimensional point coordinate set A, the influence coefficient including G and H as well as the disturbance potential data of the boundary Γ of the wind turbine blade are solved. The disturbance potential data mentioned in the present disclosure generally includes: a disturbance velocity potential φ and a derivative Q of the disturbance velocity potential φ along a blade normal direction. Subsequently, the airflow velocity at the point in the flow field region outside the boundary is calculated based on the influence coefficient and the disturbance potential data. The influence coefficients G and H may be solved through a conventional boundary element theory. The disturbance potential data may be derived based on the calculated influence coefficient in combination with a relationship among the influence coefficient, the disturbance velocity potential, and the derivative of the disturbance velocity potential along the blade normal direction. The relationship among the influence coefficient, the disturbance velocity potential, and the derivative of the disturbance velocity potential along the blade normal direction is expressed by the following equation:

$$\{ \begin{matrix}\frac{\partial φ}{\partial n} = Q \\ H \cdot φ = G \cdot Q , φ = {H}^{1} \cdot G \cdot Q\end{matrix} .$$

Next, a water droplet object is initialized. Parameters for the initialization include but are not limited to: initial position coordinates and an initial velocity. Based on the airflow velocity in the flow field region outside the boundary obtained by the aforementioned steps, in combination with the Lagrangian algorithm, a force analysis of the water droplet is performed. A force applied by an airflow on the water droplet is determined, and the motion trajectory and a velocity of the water droplet under the applied force are calculated. When the water droplet collides with the surface of the wind turbine blade, the collision position and the collision velocity of the water droplet are determined. Given a known collision position and collision velocity, the local collision coefficient at the collision position of the water droplet is obtained based on the collision velocity, the normal vector at the collision position, and the airflow velocity obtained in the above steps, in combination with the local collision coefficient calculation equation for the water droplet.

In the method for determining the water droplet collision coefficient for icing of the wind turbine blade according to the embodiments of the present disclosure, an airflow velocity at a point in a flow field region outside a boundary is obtained through a boundary element algorithm. A force state of a water droplet is determined through a Lagrangian algorithm, and a motion trajectory of the water droplet is tracked. Then a collision state of the water droplet is determined, and when the water droplet collides with a surface of a wind turbine blade, coordinates of a collision point and a collision velocity of the water droplet are rapidly calculated based on the force state and the motion trajectory of the water droplet. Finally, based on the collision velocity, a normal vector at the collision position, and the airflow velocity, in combination with a local collision coefficient calculation equation for the water droplet, necessary data for analysis of icing of the wind turbine blade, a local collision coefficient, is obtained. Since the specific process of determining the local collision coefficient in the present disclosure avoids mesh partitioning and finite element calculation, there is no requirement for constructing a complex flow field mesh model, and thereby computational efficiency is enhanced.

The above is the detailed description of the basic embodiment of the method for determining the water droplet collision coefficient for icing of the wind turbine blade according to the present disclosure. The following is a detailed description of a further embodiment of the method for determining the water droplet collision coefficient for icing of the wind turbine blade according to the present disclosure based on the above basic embodiment.

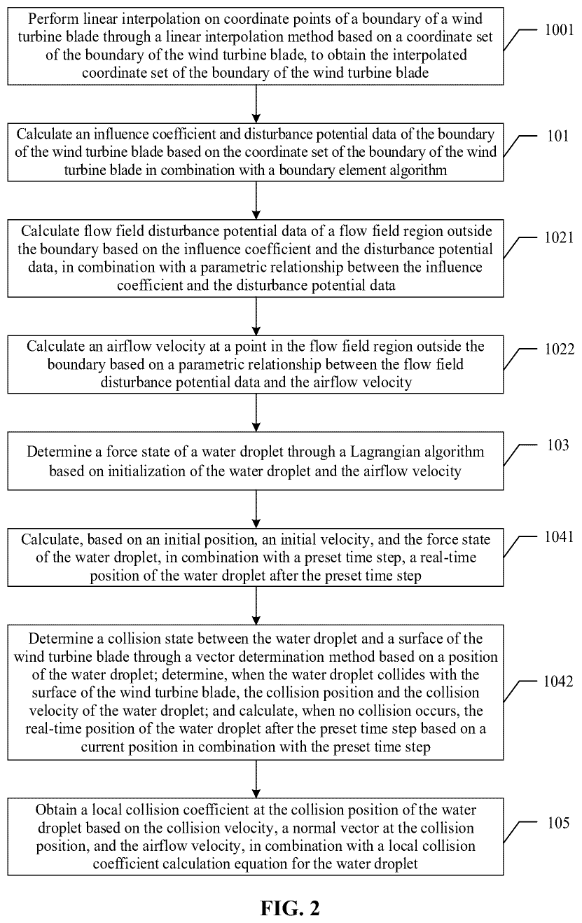

Referring to FIG. 2, a method for determining a water droplet collision coefficient for icing of a wind turbine blade according to a second embodiment of the present disclosure based on the above embodiment is described in the following.

In an embodiment, before calculating the influence coefficient and the disturbance potential data of the boundary of the wind turbine blade in combination with the boundary element algorithm in step 101, the method further includes step 1001.

In step 1001, linear interpolation is performed on coordinate points of the boundary of the wind turbine blade through a linear interpolation method based on the coordinate set of the boundary of the wind turbine blade, to obtain the interpolated coordinate set of the boundary of the wind turbine blade.

It should be noted that in the solution according to the embodiment, based on the two-dimensional point coordinate set A of the boundary Γ of the wind turbine blade, linear interpolation is performed on the set A to obtain a boundary point coordinate set B with denser coordinates. This processed coordinate set B then replace the original set A for subsequent steps, further enhancing computational precision.

In an embodiment, the calculating an airflow velocity at a point in a flow field region outside the boundary based on the influence coefficient and the disturbance potential data in step 102 further includes step 1021 to step 1022.

In step 1021, flow field disturbance potential data of the flow field region outside the boundary is calculated based on the influence coefficient and the disturbance potential data, in combination with a parametric relationship between the influence coefficient and the disturbance potential data.

In step 1022, the airflow velocity at the point in the flow field region outside the boundary is calculated based on a parametric relationship between the flow field disturbance potential data and the airflow velocity.

It should be noted that when the disturbance velocity potential φ on the boundary is determined, a disturbance potential flow value at any point in the flow field region outside the boundary is expressed as:

$$φ ( {P}_{i} ) = G \cdot \frac{\partial φ}{\partial n} - H \cdot φ .$$

By using the relationship between the potential function φ and the airflow velocity u(uₓ, u_{y}) in the boundary element algorithm, the airflow velocity at any point in the flow field region outside the boundary is solved. The relationship among the potential function φ, the disturbance velocity potential φ, and the airflow velocity u(uₓ, u_{y}) is expressed as follows:

$$\{ \begin{matrix}ϕ = φ + {φ}_{0} \\ \frac{\partial ϕ}{\partial x} = {u}_{x} , \frac{\partial ϕ}{\partial y} = {u}_{y}\end{matrix} ,$$

where φ₀ is a potential function value which is infinitely far from the boundary of the wind turbine blade, and is expressed as:

$${φ}_{0} = {\int }_{x}^{x = ∞} u ( x ) dx = {u}_{∞} x .$$

In an embodiment, the tracking a motion trajectory of the water droplet based on the force state of the water droplet, and determining a collision position and a collision velocity of the water droplet when the water droplet collides with a surface of the wind turbine blade in step 104 further includes step 1041 and step 1042.

In step 1041, in combination with a preset time step, a real-time position of the water droplet after the preset time step is calculated based on an initial position, an initial velocity, and the force state of the water droplet.

In step 1042, a collision state between the water droplet and the surface of the wind turbine blade is determined through a vector determination method based on a position of the water droplet; when the water droplet collides with the surface of the wind turbine blade, the collision position and the collision velocity of the water droplet are determined; and when no collision occurs, the real-time position of the water droplet after the preset time step is calculated based on a current position in combination with the preset time step.

It should be noted that based on the force analysis of the water droplet, the drag force applied by the airflow on the water droplet and the velocity of the water droplet are solved. As shown in FIG. 3, a position that the water droplet reaches after a time step dt is calculated. An airflow viscous resistance (the airflow drag force) applied on the water droplet is expressed as:

$${F}_{d} = {m}_{w} \frac{d v}{d t} = \frac{1}{2} {ρ}_{a} {S}_{w} {C}_{a} \vert u - v \vert ( u - v ) ,$$

where m_{w} represents a mass (kg) of the water droplet; S_{w} represents a maximum cross-sectional area (m²) of the water droplet; u and v represent two-dimensional velocity vectors (m/s) of the airflow and the water droplet, respectively; and pa represents an air density (kg/m³).

During tracking and calculating the motion trajectory of the water droplet, the time step dt is reduced after the water droplet approaches the wind turbine blade, and it is determined that whether the water droplet collides with the surface of the blade through the vector determination method. When the water droplet collides with the surface of the wind turbine blade, the collision position and the collision velocity of the water droplet are determined; and when no collision occurs, the real-time position of the water droplet after the preset time step is calculated based on the current position in combination with the preset time step.

For determining the collision position and the collision velocity of the water droplet, as shown in FIG. 4, each time the water droplet P moves forward a distance of one time step, a line element O(xⱼ, yⱼ) on the wind turbine blade closest to the water droplet P(xᵢ, yᵢ) is solved. A normal vector of the line element O is nⱼ(nⱼₓ, n_{jy}). The collision state between the water droplet P and the wind turbine blade is expressed as follows.

$$\{ \begin{matrix}\vec{{O}_{j} P} \cdot {n}_{j} = ( {x}_{j} − {x}_{i} ) {n}_{j x} + ( {y}_{j} − {y}_{i} ) {n}_{j y} > 0 , the water droplet collides with the wind turbine blade \\ \vec{{O}_{j} P} \cdot {n}_{j} = ( {x}_{j} − {x}_{i} ) {n}_{j x} + ( {y}_{j} − {y}_{i} ) {n}_{j y} \leq 0 , no collision occurs between the water droplet and the wind turbine blade\end{matrix}$$

Given the collision position and the collision velocity, distribution of the local collision coefficient β₁ of the water droplet is calculated through the method according to the present disclosure. Assuming that the airflow velocity is represented as U and the collision velocity of the water droplet P on the line element O of the wind turbine blade is represented as Vₚ(Vₓ, V_{y}), the value of the local collision coefficient of the water droplet at the collision position is obtained by the following equation:

$${β}_{1}^{P} = \frac{{V}_{x} {n}_{jx} + {V}_{y} {n}_{jy}}{U} .$$

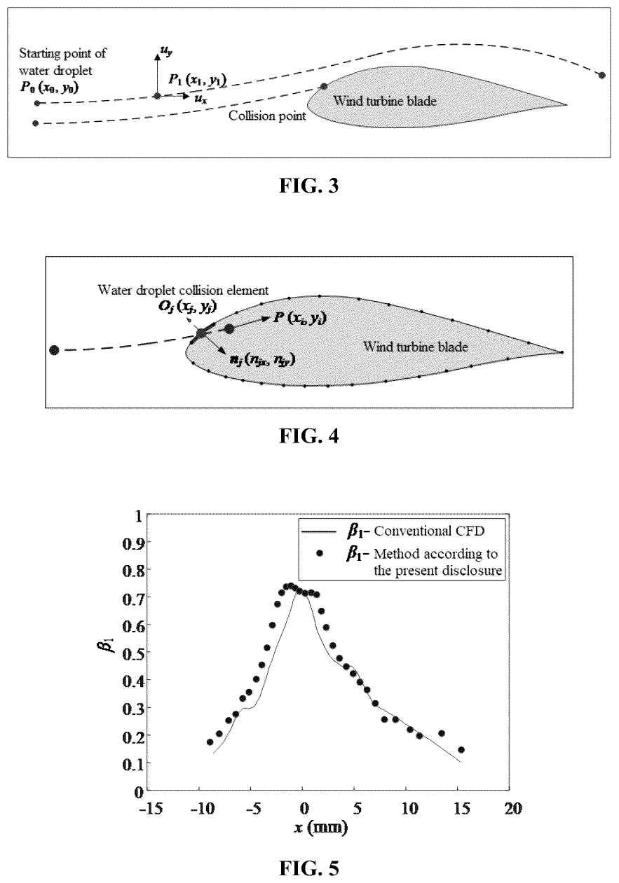

As shown in FIG. 5, compared with a calculated value of the local collision coefficient of the water droplet obtained by a conventional computational fluid dynamics (CFD) method, it can be observed that the result obtained by the present disclosure exhibits a high accuracy with errors within an acceptable range. Also, in the present disclosure, steps of mesh partitioning and finite element calculation are avoided, thereby improving computational efficiency.

Furthermore, the process of tracking the motion trajectory of the water droplet further includes:

based on the motion trajectory of the water droplet, in combination with a preset motion trajectory smoothness value, when a smoothness of the motion trajectory is less than the preset motion trajectory smoothness value, reducing the preset time step until the smoothness of the motion trajectory is not less than the preset motion trajectory smoothness value.

Furthermore, the process of tracking the motion trajectory of the water droplet further includes:
based on a distance between the current position of the water droplet and the surface of the wind turbine blade, when the distance is greater than a preset distance threshold and the smoothness of the motion trajectory is not less than the preset motion trajectory smoothness value, increasing the preset time step.

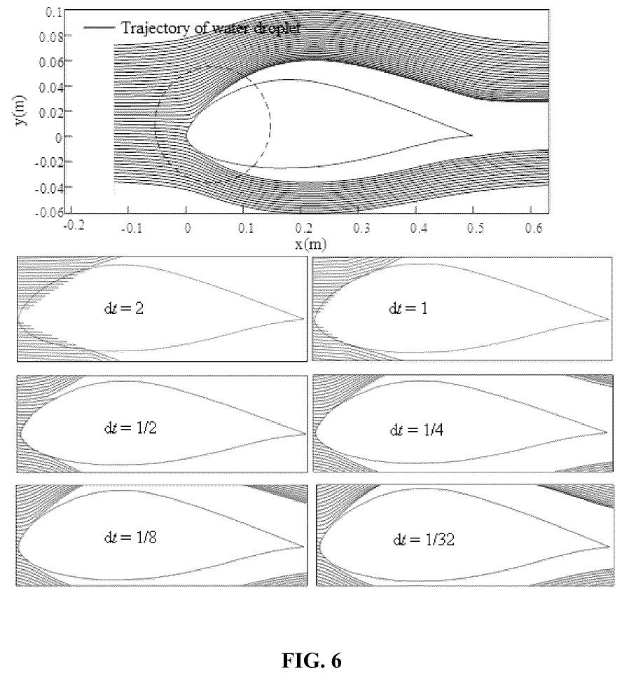

It should be noted that to further enhance computational efficiency, in this embodiment, the time step dt is adjusted based on the smoothness of the motion trajectory of the water droplet through a dynamic control strategy. When a motion trajectory curve of the water droplet becomes distorted, it indicates that the value of the time step dt is too large and should be reduced. As shown in FIG. 6, when the time step dt is adjusted from 1 to 1/32, the motion trajectory of the water droplet gradually becomes smooth. Additionally, when the smoothness of the motion trajectory is satisfactory and the water droplet is sufficiently distant from the wind turbine blade, the time step may be appropriately increased to reduce computational time.

The above is the detailed description of the further embodiment of the method for determining the water droplet collision coefficient for icing of the wind turbine blade according to the present disclosure. The following is a detailed description of an embodiment of an apparatus for determining a water droplet collision coefficient for icing of a wind turbine blade according to the present disclosure.

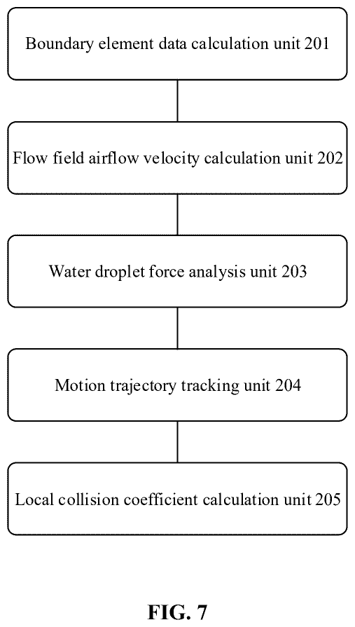

Referring to FIG. 7, an apparatus for determining a water droplet collision coefficient for icing of a wind turbine blade is provided according to an embodiment, and the apparatus includes a boundary element data calculation unit 201, a flow field airflow velocity calculation unit 202, a water droplet force analysis unit 203, a motion trajectory tracking unit 204, and a local collision coefficient calculation unit 205.

The boundary element data calculation unit 201 is configured to calculate an influence coefficient and disturbance potential data of a boundary of the wind turbine blade based on a coordinate set of the boundary of the wind turbine blade in combination with a boundary element algorithm.

The flow field airflow velocity calculation unit 202 is configured to calculate an airflow velocity at a point in a flow field region outside the boundary based on the influence coefficient and the disturbance potential data.

The water droplet force analysis unit 203 is configured to determine a force state of a water droplet through a Lagrangian algorithm based on initialization of the water droplet and the airflow velocity.

The motion trajectory tracking unit 204 is configured to track a motion trajectory of the water droplet based on the force state of the water droplet, and determine a collision position and a collision velocity of the water droplet when the water droplet collides with a surface of the wind turbine blade.

The local collision coefficient calculation unit 205 is configured to obtain a local collision coefficient at the collision position of the water droplet based on the collision velocity, a normal vector at the collision position, and the airflow velocity, in combination with a local collision coefficient calculation equation for the water droplet.

The above is the detailed description of the embodiment of the apparatus for determining the water droplet collision coefficient for icing of the wind turbine blade according to the present disclosure. The following is detailed descriptions of embodiments of a terminal for determining a water droplet collision coefficient for icing of a wind turbine blade and a computer-readable storage medium according to the present disclosure.

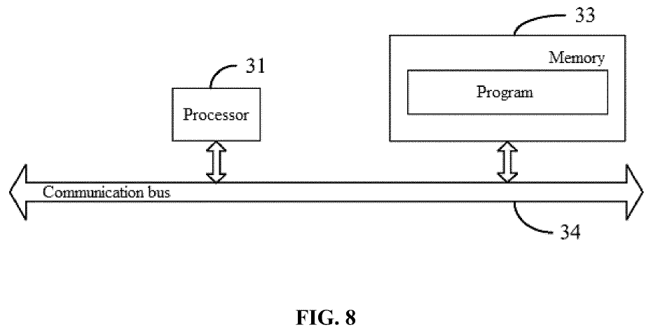

Referring to FIG. 8, a terminal for determining a water droplet collision coefficient for icing of a wind turbine blade is provided according to a fourth embodiment of the present disclosure. The type of the terminal includes but is not limited to: a personal computer, an industrial computer, a server, and an embedded intelligent device. The terminal for determining the water droplet collision coefficient for icing of the wind turbine blade according to the embodiment includes a memory 33 and a processor 31, and the memory and the processor are connected via a bus 34.

The memory 33 stores a computer program executable on the processor 31.

The processor 31, when executing the computer program, implements the method for determining the water droplet collision coefficient for icing of the wind turbine blade according to the first embodiment or the second embodiment of the present disclosure.

A computer-readable storage medium is provided according to a fifth embodiment of the present disclosure. The computer-readable storage medium stores computer-executable instructions. The computer-executable instructions, when executed by a control processor, cause the control processor to implement the method for determining the water droplet collision coefficient for icing of the wind turbine blade according to the first embodiment or the second embodiment of the present disclosure.

Those skilled in the art can clearly understand that, for the convenience and conciseness of description, the specific operation processes of the terminal, apparatus and unit may be with reference to the corresponding processes in the method embodiments, and are not described in detail here.

In the embodiments according to the present disclosure, it should be understood that the disclosed terminal, apparatus, and method may be implemented in other ways. For example, the apparatus embodiments described above are only schematic. For example, the division of the units is only a division according to logical functions, and there may be other division manners in practical implementations. For example, multiple units or components may be combined or may be integrated into another system, or some features may be omitted or may be not implemented. In addition, the mutual couplings or direct couplings or communication connections shown or discussed above may be indirect couplings or communication connections through some interfaces, apparatuses or units, and may be in electrical, mechanical or other forms.

In the specification and the accompanying drawings of the present disclosure, the terms “first”, “second”, “third”, “fourth”, and the like (if existing) are intended to distinguish between similar objects rather than describe a specific sequence or a precedence order. It should be understood that the data used in this way may be interchanged in appropriate situations, so that the embodiments of the present disclosure may be implemented in an order other than those illustrated or described herein. In addition, the terms “include,” “comprise”, and any other variants thereof are intended to cover the non-exclusive inclusion. For example, a process, method, system, product, or device that includes a list of steps or units is not necessarily limited to those expressly listed steps or units, but may include other steps or units not expressly listed or inherent to such process, method, product, or device.

It should be understood that in the present disclosure, the term “at least one” refers to a quantity equal to one or more, and the term “multiple” refers to a quantity equal to two or more. The term “and/or” is used to describe an association relationship between objects, and indicates three possible relationships. For example, “A and/or B” may indicate a case in which only A exists, a case in which only B exists, or a case in which both A and B exist. In the above cases, each of A and B may be singular or plural. The symbol “/” generally indicates that a former object and a latter object are associated by an “or” relationship. The expression of “at least one of the following” or a similar expression refers to any combination of items, including any combination of single items or plural items. For example, at least one of a, b, or c may indicate: a, b, c, “a and b”, “a and c”, “b and c”, or “a, b, and c”, where each of a, b, and c may be singular or plural.

The unit described as a separate component may be or may be not separated physically. The component displayed as a unit may be or may be not a physical unit, that is, may be located at one place or may be distributed on multiple network units. Some or all of the units may be selected according to actual needs to achieve the objectives of the technical solutions according to the present disclosure.

In addition, the functional units in the embodiments of the present disclosure may be integrated into one processing unit or may be units physically independently. Two or more units may be integrated in one unit. The integrated unit may be implemented in a form of hardware or in a form of a software functional unit.

In a case that the integrated unit is implemented as a software function unit and is sold or used as an independent product, it may be stored in a computer-readable storage medium. Based on such understanding, the essence of the technical solutions of the present disclosure, or parts of the technical solutions which contribute to the conventional technology, or all or parts of the technical solutions may be embodied in a form of a software product. The computer software product is stored in a storage medium, and includes several instructions which enables a computer device (such as a personal computer, a server, or a network device) to perform all or part of the method according to the embodiments of the present disclosure. The foregoing storage medium includes a U disk, a removable hard disk, a read-only memory (ROM), a random-access memory (RAM), a magnetic disk, an optical disk, or other media that can store program codes.

The foregoing embodiments are used for describing, instead of limiting the technical solutions of the present disclosure. Those skilled in the art shall understand that although the present disclosure has been described in detail with reference to the foregoing embodiments, modifications can be made to the technical solutions described in the foregoing embodiments, or equivalent replacements may be made to some technical features in the technical solutions, provided that such modifications or replacements do not cause the essence of corresponding technical solutions to depart from the spirit and scope of the technical solutions of the embodiments of the present disclosure.

1. A method for determining a water droplet collision coefficient for icing of a wind turbine blade, comprising:
calculating an influence coefficient and disturbance potential data of a boundary of the wind turbine blade based on a coordinate set of the boundary of the wind turbine blade in combination with a boundary element algorithm;
calculating an airflow velocity at a point in a flow field region outside the boundary based on the influence coefficient and the disturbance potential data;
determining a force state of a water droplet through a Lagrangian algorithm based on initialization of the water droplet and the airflow velocity;
tracking a motion trajectory of the water droplet based on the force state of the water droplet, and determining a collision position and a collision velocity of the water droplet when the water droplet collides with a surface of the wind turbine blade; and
obtaining a local collision coefficient at the collision position of the water droplet based on the collision velocity, a normal vector at the collision position, and the airflow velocity, in combination with a local collision coefficient calculation equation for the water droplet.

2. The method for determining the water droplet collision coefficient for icing of the wind turbine blade according to claim 1, wherein the local collision coefficient calculation equation for the water droplet is expressed as:
$${β}_{1}^{P} = \frac{{V}_{x} {n}_{jx} + {V}_{y} {n}_{jy}}{U} ,$$
wherein β₁^{P} represents a local collision coefficient of a water droplet P, Vₓ represents an x-axis component of the collision velocity, V_{y} represents a y-axis component of the collision velocity, U represents the airflow velocity, nⱼₓ represents an x-axis component of the normal vector at the collision position when the water droplet collides with the surface of the blade, and n_{jy} represents a y-axis component of the normal vector at the collision position when the water droplet collides with the surface of the blade.

3. The method for determining the water droplet collision coefficient for icing of the wind turbine blade according to claim 1, wherein the calculating an airflow velocity at a point in a flow field region outside the boundary based on the influence coefficient and the disturbance potential data further comprises:
calculating flow field disturbance potential data of the flow field region outside the boundary based on the influence coefficient and the disturbance potential data, in combination with a parametric relationship between the influence coefficient and the disturbance potential data; and
calculating the airflow velocity at the point in the flow field region outside the boundary based on a parametric relationship between the flow field disturbance potential data and the airflow velocity.

4. The method for determining the water droplet collision coefficient for icing of the wind turbine blade according to claim 1, wherein before calculating the influence coefficient and the disturbance potential data of the boundary of the wind turbine blade in combination with the boundary element algorithm, the method further comprises:
performing linear interpolation on coordinate points of the boundary of the wind turbine blade through a linear interpolation method based on the coordinate set of the boundary of the wind turbine blade, to obtain the interpolated coordinate set of the boundary of the wind turbine blade.

5. The method for determining the water droplet collision coefficient for icing of the wind turbine blade according to claim 1, wherein the tracking a motion trajectory of the water droplet based on the force state of the water droplet, and determining a collision position and a collision velocity of the water droplet when the water droplet collides with a surface of the wind turbine blade further comprises:
calculating, based on an initial position, an initial velocity, and the force state of the water droplet, in combination with a preset time step, a current position of the water droplet after the preset time step;
determining a collision state between the water droplet and the surface of the wind turbine blade through a vector determination method based on the current position of the water droplet;
determining, when the water droplet collides with the surface of the wind turbine blade, the collision position and the collision velocity of the water droplet; and
calculating, when no collision occurs, a next position of the water droplet after the preset time step based on the current position in combination with the preset time step.

6. The method for determining the water droplet collision coefficient for icing of the wind turbine blade according to claim 5, wherein the process of tracking the motion trajectory of the water droplet further comprises:
based on the motion trajectory of the water droplet, in combination with a preset motion trajectory smoothness value, when a smoothness of the motion trajectory is less than the preset motion trajectory smoothness value, reducing the preset time step until the smoothness of the motion trajectory is not less than the preset motion trajectory smoothness value.

7. The method for determining the water droplet collision coefficient for icing of the wind turbine blade according to claim 6, wherein the process of tracking the motion trajectory of the water droplet further comprises:
based on a distance between the current position of the water droplet and the surface of the wind turbine blade, when the distance is greater than a preset distance threshold and the smoothness of the motion trajectory is not less than the preset motion trajectory smoothness value, increasing the preset time step.

8. An apparatus for determining a water droplet collision coefficient for icing of a wind turbine blade, comprising:
a boundary element data calculation unit, configured to calculate an influence coefficient and disturbance potential data of a boundary of the wind turbine blade based on a coordinate set of the boundary of the wind turbine blade in combination with a boundary element algorithm;
a flow field airflow velocity calculation unit, configured to calculate an airflow velocity at a point in a flow field region outside the boundary based on the influence coefficient and the disturbance potential data;
a water droplet force analysis unit, configured to determine a force state of a water droplet through a Lagrangian algorithm based on initialization of the water droplet and the airflow velocity;
a motion trajectory tracking unit, configured to track a motion trajectory of the water droplet based on the force state of the water droplet, and determine a collision position and a collision velocity of the water droplet when the water droplet collides with a surface of the wind turbine blade; and
a local collision coefficient calculation unit, configured to obtain a local collision coefficient at the collision position of the water droplet based on the collision velocity, a normal vector at the collision position, and the airflow velocity, in combination with a local collision coefficient calculation equation for the water droplet.

9. A terminal for determining a water droplet collision coefficient for icing of a wind turbine blade, comprising: a memory and a processor, wherein
the memory stores a computer program executable on the processor; and
the processor, when executing the computer program, implements the method for determining the water droplet collision coefficient for icing of the wind turbine blade according to claim 1.

10. A computer-readable storage medium, storing computer-executable instructions, wherein the computer-executable instructions, when executed by a control processor, cause the control processor to implement the method for determining the water droplet collision coefficient for icing of the wind turbine blade according to claim 1.
